(19) United States
(12) Patent Application Publication
(10) Pub. No.: US 2019/0024684 A1
(43) Pub. Date: Jan. 24, 2019

(54) PNEUMATIC CLAMPING COMPONENT

(71) Applicant: LOTES CO., LTD, Keelung (TW)

(72) Inventors: Yung Sheng Kung, Keelung (TW); Jian Hu, Keelung (TW)

(21) Appl. No.: 15/831,861

(22) Filed: Dec. 5, 2017

(30) Foreign Application Priority Data
Jul. 18, 2017 (CN) 201710608745.X

(51) Int. Cl. F16B 2/06; B23Q 3/06; B23Q 3/08

(52) U.S. Cl. CPC F16B 2/06; B25B 5/061; B23Q 3/08; B23Q 3/061

(57) ABSTRACT

A pneumatic clamping component includes a clamping member having a main body portion, an abutting portion, and clamping arms. Each clamping arm has a connecting portion and a clamping portion. A base has an accommodating cavity in communication with an air opening. The abutting portion, the clamping arms and an inner wall of the accommodating cavity jointly form an air chamber in communication with the air opening. The air opening is used for entry of air and keeps the air in the air chamber. The clamping portion is located outside the air chamber. A gap is located between the two clamping arms. When the air does not enter the air chamber, two clamping portions are not in contact with the to-be-clamped object. When the air enters the air chamber, a to-be-clamped object is located in the gap, and the two clamping portions clamp the to-be-clamped object.

### CROSS-REFERENCE TO RELATED PATENT APPLICATION

This application claims priority to and the benefit of, pursuant to 35 U.S.C. § 119(a), patent application Serial No. CN201710608745.X filed in China on Jul. 18, 2017. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a pneumatic clamping component, and in particular, to a pneumatic clamping component having a simple structure.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A pneumatic clamping component is configured for clamping various objects. Currently, most of the pneumatic clamping components in the market are transmission mechanisms and action conversion mechanisms formed by pistons and mechanical components. Due to large overall volumes and complex structures, it is extremely inconvenient to install and maintain the pneumatic clamping components, and production costs are relatively high. In addition, when a piston is pushed by air to match with a transmission mechanism so as to clamp a to-be-clamped object, the efficiency is low and clamping force is weak.

Therefore, a heretofore unaddressed need to design a new pneumatic clamping component exists in the art to address the aforementioned deficiencies and inadequacies.

### SUMMARY

In view of the problem addressed in the background technology, an objective of the present invention is to provide a pneumatic clamping component having a simple structure and easy to be assembled, in which an air chamber is disposed to match a clamping arm.

To achieve the foregoing objective, the present invention adopts the following technical solutions.

A pneumatic clamping component, configured for entry of air so as to clamp a to-be-clamped object. The pneumatic clamping component includes: a clamping member, comprising a main body portion, wherein at least two clamping arms are provided at a side of the main body portion, each of the clamping arms comprises a connecting portion and a clamping portion extending from the connecting portion, the connecting portion is connected to the main body portion, and the clamping portion is configured for clamping the to-be-clamped object; at least one base, comprising an accommodating cavity, at least one air opening being in communication with the accommodating cavity; and at least one abutting portion located between and in contact with one of the clamping arms and a corresponding inner wall of the accommodating cavity, wherein the abutting portion, the one of the clamping arms, and the inner wall of the accommodating cavity jointly form an air chamber, the air opening is in communication with the air chamber, the air opening is configured for entry of air and keeping the air in the air chamber, and the clamping portion is located outside the air chamber; and at least one gap located between the two connecting portions and extending to be between the two clamping portions, wherein when the air does not enter the air chamber, the to-be-clamped object is configured to be located in the gap, and the two clamping portions are not in contact with the to-be-clamped object; and when the air enters the air chamber, the to-be-clamped object is located in the gap, and the two clamping portions clamp the to-be-clamped object.

In certain embodiments, the base comprises an upper base body and a lower base body provided opposite to each other, two lateral base bodies provided opposite to each other and jointly forming the accommodating cavity with the upper base body and the lower base body, and a front base body located at a front end of the accommodating cavity, wherein the main body portion and the two clamping arms are located between the two lateral base bodies, the abutting portion is in contact with an end of each of the lateral base bodies away from the front base body, and the front base body, the main body portion, the connecting portion, the abutting portion and the inner wall of the accommodating cavity surroundingly form the air chamber.

In certain embodiments, the air opening penetrates through the front base body along an extending direction of the clamping arms.

In certain embodiments, the two lateral base bodies, the upper base body, the lower base body, and the front base body are separately formed, and are assembled to one another to form the base.

In certain embodiments, a height of the main body portion, a height of the connecting portion, a height of the abutting portion and heights of the two lateral base bodies are same, the main body portion, the connecting portion, the abutting portion are located between the upper base body and the lower base body, and the front base body abuts the two lateral base bodies and the main body portion.

In certain embodiments, the inner wall of the accommodating cavity is concavely provided with two first grooves opposite to each other, the two sides of the main body portion form two air grooves respectively corresponding to the first grooves, each of the air grooves, the air opening and the air chamber are in communication with one another, and the air enters the air chamber by sequentially passing through the air opening and the air grooves.

In certain embodiments, the two sides of the main body portion are correspondingly provided with two second grooves respectively, and each of the first grooves and each of the second grooves correspondingly form one of the air grooves.

In certain embodiments, the air opening and the two air grooves are staggeredly provided along an extending direction of the clamping arms.

In certain embodiments, two abutting portions are provided, the two abutting portions are respectively located between and are in contact with the two clamping arms and the corresponding inner wall of the accommodating cavity; wherein air is located in two air chambers, one of the abutting portions, one of the clamping arms, and the inner wall of the accommodating cavity jointly form one of the air chambers, and the other of the abutting portions, the other of the clamping arms, and the inner wall of the accommodating cavity jointly form the other of the air chambers.

In certain embodiments, the abutting portion is formed by integrally extending from one of the clamping arms.

In certain embodiments, a first protruding portion is provided at a joint location between the abutting portion and the connecting portion, wherein when the air does not enter the air chamber, an inner wall of the base laterally abuts the first protruding portion, and an end of the abutting portion near the main body portion is in contact with the inner wall of the base; and when the air enters the air chamber, the inner wall of the base is separated from the first protruding portion, and the end of the abutting portion near the main body portion is in contact with the inner wall of the base.

In certain embodiments, a reserved groove is provided at a joint location between the first protruding portion and the abutting portion, and the inner wall of the base partially enters the reserved groove.

In certain embodiments, a sealing member is provided between the abutting portion and an inner wall of the base, and the sealing member respectively abuts the abutting portion and an inner wall of the base.

In certain embodiments, the inner wall of the base is concavely provided with an accommodating groove, the sealing member is located in the accommodating groove, and the sealing member presses against the abutting portion.

In certain embodiments, the abutting portion is obliquely provided along a direction away from the connecting portion, and an inner wall of the base is obliquely provided correspondingly.

In certain embodiments, two extending portions are provided at one end of the main body portion near the connecting portion, and the two extending portions are respectively located on two sides of the two connecting portions away from the gap.

In certain embodiments, the main body portion, the connecting portion, and the abutting portion are made of a sealing material.

In certain embodiments, a width of the connecting portion gradually decreases towards a direction of the clamping portions.

In certain embodiments, each of the two clamping arms is provided with a second protruding portion located in the gap.

In certain embodiments, at least one of the connecting portions is movably connected to the main body portion by a fixing member.

In certain embodiments, one of the clamping arms extends along a direction towards the other of the clamping arms to form an inserting portion, the other of the clamping arms is correspondingly provided with a inserting opening, and when the air enters the air chamber, the inserting portion is located on the inserting opening.

In certain embodiments, the abutting portion is formed by extending from a side of the other of the clamping arms away from the gap, and the inserting opening further extends into the abutting portion.

In certain embodiments, at least one first airbag is accommodated in the air chamber, the first airbag comprises a first air nozzle in communication with the air opening, and the air enters the first air nozzle through the air opening and is located in the first airbag.

In certain embodiments, the inner wall of the accommodating cavity is concavely provided with two first grooves opposite to each other, the two sides of the main body portion are correspondingly provided with two second grooves respectively, and each of the first grooves and each of the second grooves correspondingly form an air groove, each of the first grooves is concavely provided with a first recess portion at a location away from the air opening, each of the second grooves is concavely provided with a second recess portion correspondingly, the first recess portion and the second recess portion are respectively in lateral communication with the air groove, the first air nozzles are located in the first recess portion and the second recess portion, and the air sequentially enters the air opening and the air groove to be located in the first airbag.

In certain embodiments, at least one second airbag is located in the gap, the second airbag comprises a second air nozzle; a through hole is located in the main body portion, and the second air nozzle is in communication with the through hole, wherein the air enters the second air nozzle through the through hole to be located in the second airbag.

In the foregoing pneumatic clamping component, the two clamping arms are provided, and the abutting portion, the clamping arms, and the inner wall of the accommodating cavity jointly form the air chamber. The air enters the air chamber through the air opening. The gap is located between the two connecting portions and extends to be between the two clamping portions. When the air does not enter the air chamber, the to-be-clamped object is configured to be located in the gap, and the two clamping portions are not in contact with the to-be-clamped object. When the air enters the air chamber, the to-be-clamped object is located in the gap, so that the two clamping portions clamp the to-be-clamped object. The entire pneumatic clamping component does not need a mechanical auxiliary mechanism, has a simple structure, and is easy to be assembled, thereby reducing costs. In addition, the air directly arrives at the air chamber through the air opening, so that a flow path of the air is short, effectively improving the efficiency.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of a pneumatic clamping component according to a first embodiment of the present invention;

FIG. 2 is a perspective exploded view of the pneumatic clamping component in another viewing angle according to the first embodiment of the present invention;

FIG. 3 is a perspective partial assembly view of the pneumatic clamping component according to the first embodiment of the present invention;

FIG. 4 is a perspective combination view of the pneumatic clamping component according to the first embodiment of the present invention;

FIG. 5 is a cross-sectional view along an A-A line of the pneumatic clamping component being loosened according to the first embodiment of the present invention;

FIG. 6 is a cross-sectional view of the pneumatic clamping component being clamped according to the first embodiment of the present invention;

FIG. 7 is a perspective exploded view of a pneumatic clamping component according to a second embodiment of the present invention;

FIG. 8 is a cross-sectional view of the pneumatic clamping component being loosened according to the second embodiment of the present invention;

FIG. 9 is a cross-sectional view of the pneumatic clamping component being clamped according to the second embodiment of the present invention;

FIG. 10 is a perspective exploded view of a pneumatic clamping component according to a third embodiment of the present invention;

FIG. 11 is a cross-sectional view of the pneumatic clamping component being loosened according to the third embodiment of the present invention;

FIG. 12 is a cross-sectional view of the pneumatic clamping component being clamped according to the third embodiment of the present invention;

FIG. 13 is a perspective exploded view of a pneumatic clamping component according to a fourth embodiment of the present invention;

FIG. 14 is a cross-sectional view of the pneumatic clamping component being loosened according to the fourth embodiment of the present invention; and

FIG. 15 is a cross-sectional view of the pneumatic clamping component being clamped according to the fourth embodiment of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

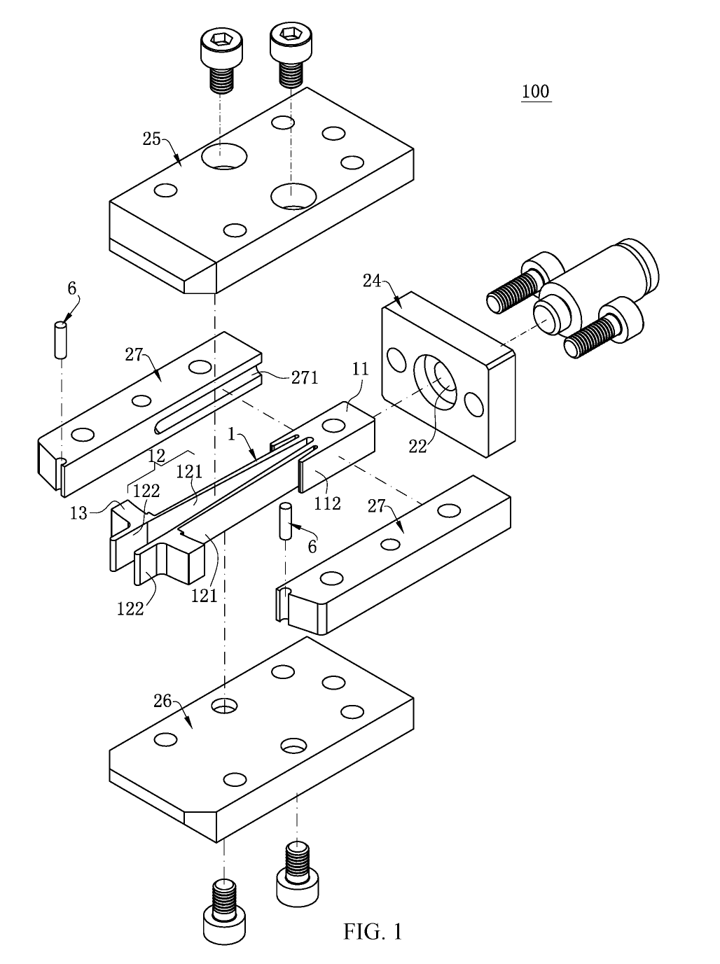

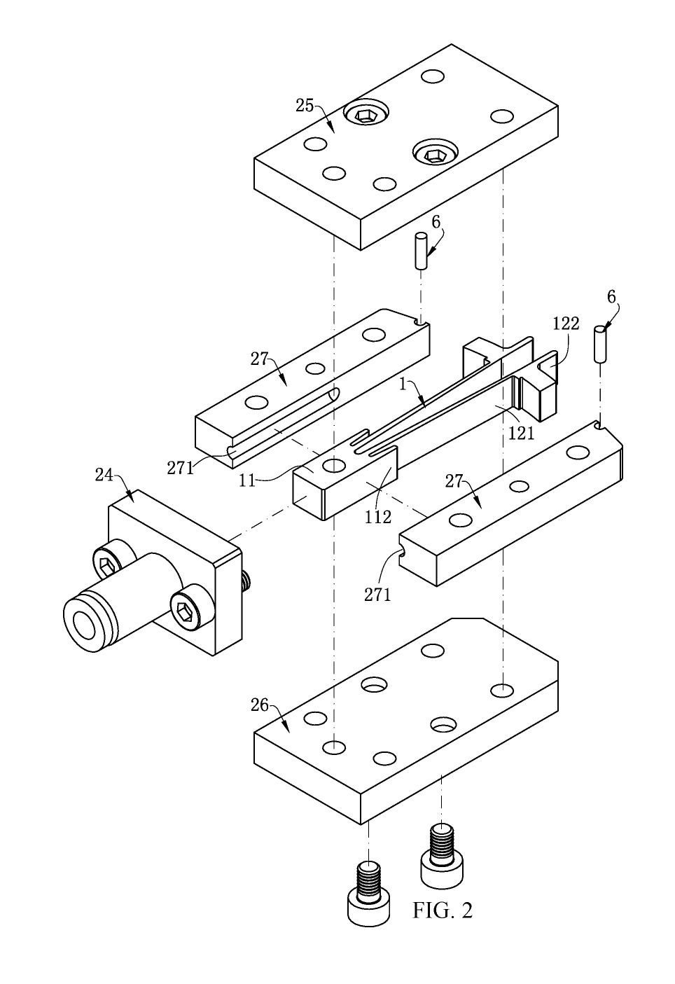

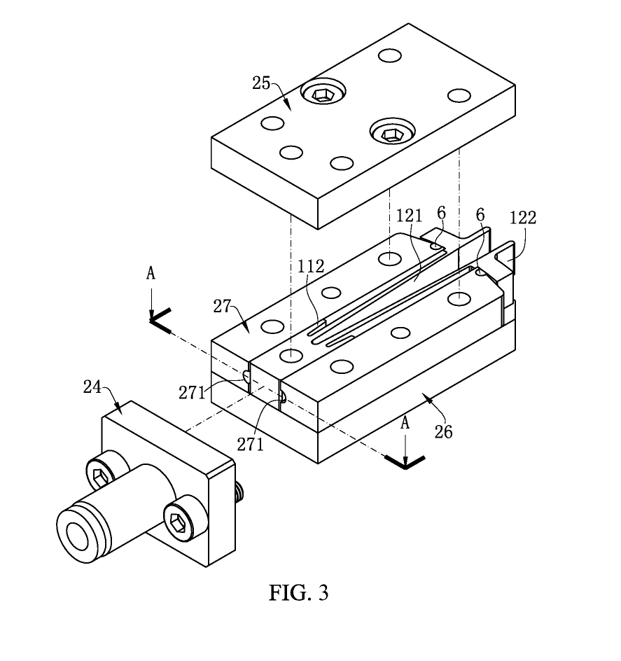

The description will be made as to the embodiments of the present invention in conjunction with the accompanying drawings in FIGS. 1-15. In accordance with the purposes of this invention, as embodied and broadly described herein, this invention, in one aspect, relates to a pneumatic clamping component.

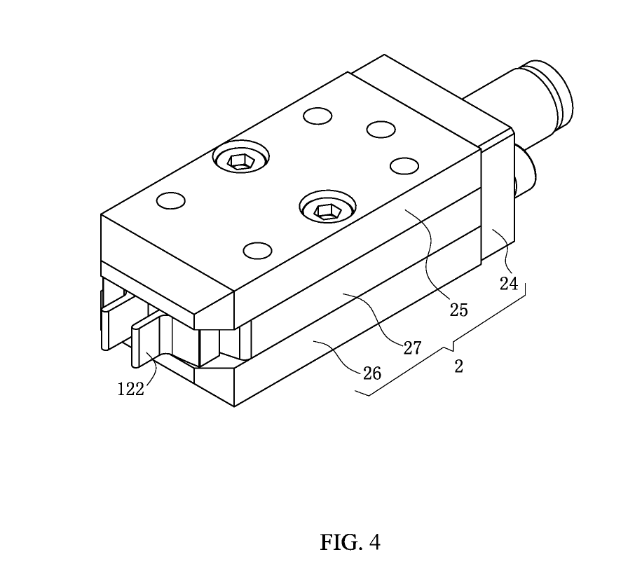

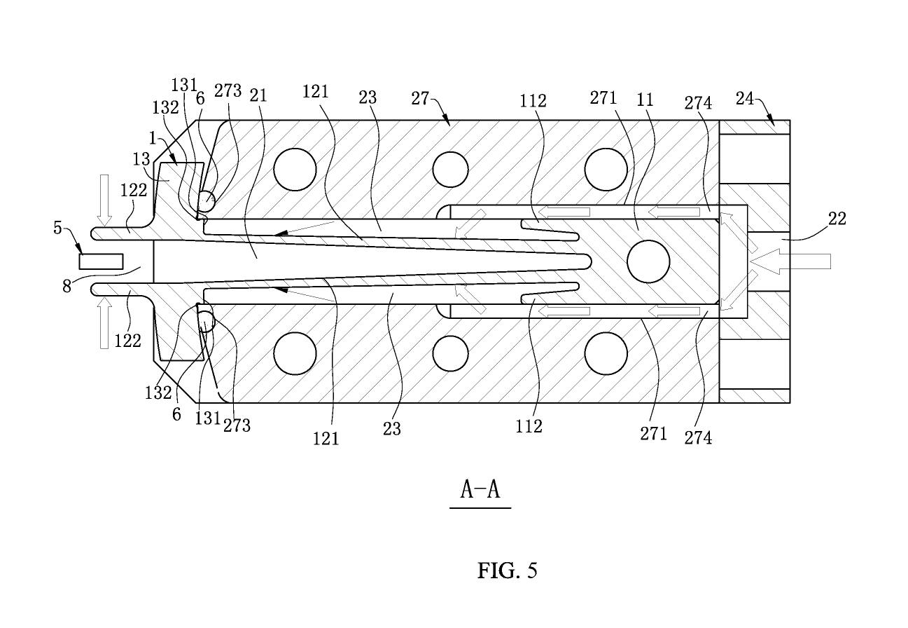

FIG. 1, FIG. 4, and FIG. 5 show a pneumatic clamping component 100 according to a first embodiment of the present invention. The pneumatic clamping component 100 includes a base 2 and a clamping member 1. The clamping member 1 is disposed on the base 2. The pneumatic clamping component 100 is configured for entry of air, so as to clamp a to-be-clamped object 5.

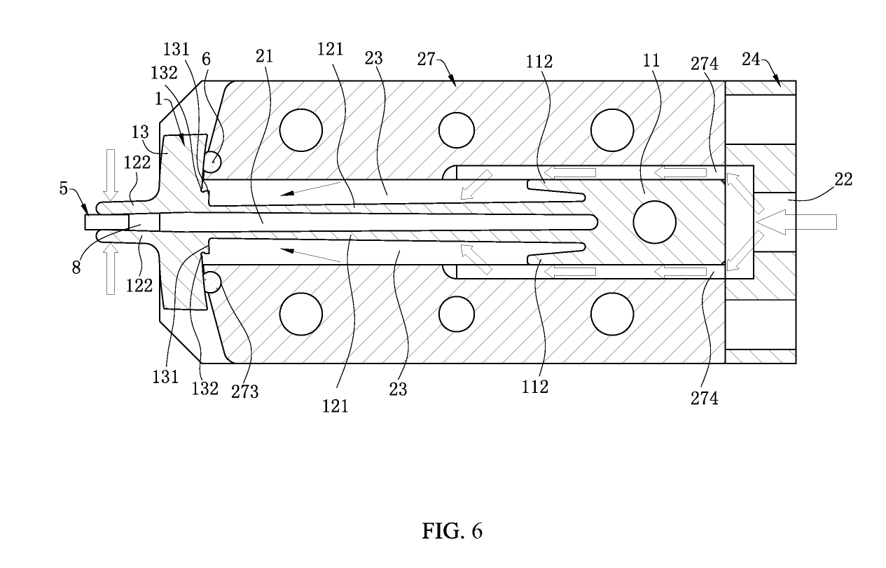

As shown in FIG. 1, FIG. 5, and FIG. 6, the base 2 has an upper base body 25 and a lower base body 26 provided opposite to each other on the base 2. Two lateral base bodies 27 are provided opposite to each other, and jointly form an accommodating cavity 21 with the upper base body 25 and the lower base body 26. A front base body 24 is located at a front end of the accommodating cavity 21. An air opening 22 is formed to penetrate front-to-back through the front base body 24, and the air opening 22 is in communication with the accommodating cavity 21. Two opposite first grooves 271 are concavely provided respectively at two opposite sides of the two lateral base bodies 27, and two accommodating grooves 273 are concavely provided at two ends of the two lateral base bodies 27 away from the front base body 24 respectively. The two lateral base bodies 27, the upper base body 25, the lower base body 26, and the front base body 24 are separately formed, and are assembled to one another by a plurality of screws to form the base 2. The base 2 has a simple structure and is convenient for maintenance. In another embodiment, the base 2 may alternatively be integrally formed. When the base 2 is integrally formed, it is easy to assemble the base 2, and there is a high matching accuracy among the lateral base bodies 27, the upper base body 25, the lower base body 26, and the front base body 24.

As shown in FIG. 5, the clamping member 1 includes a main body portion 11. Two clamping arms 12 are provided at a side of the main body portion 11. Each of the clamping arms 12 includes a connecting portion 121 and a clamping portion 122 extending from the connecting portion 121. The connecting portion 121 is connected to the main body portion 11. The clamping portion 122 is configured for clamping the to-be-clamped object 5. A profile of the clamping portion 122 may be correspondingly adjusted according to a profile of the to-be-clamped object 5, in order to maximize the clamping force. A gap 8 is located between the two connecting portions 121, and extends to be between the two clamping portions 122. The to-be-clamped object 5 is located in the gap 8. The gap 8 reduces collisions caused by excessive movement between the clamping arms 12, and also maintains elasticity of the clamping arms 12, so that it is easier to clamp the to-be-clamped object 5.

As shown in FIG. 5, each of the clamping arms 12 integrally extends to form an abutting portion 13. A first protruding portion 131 is provided at a joint location between the abutting portion 13 and the connecting portion 121. Two extending portions 112 are provided at one end of the main body portion 11 near the connecting portion 121, and the two extending portions 112 are respectively located on two sides of the two connecting portions 121 away from the gap 8. The extending portion 112 is configured for limiting lateral movements of the clamping arms 12, to prevent the collision between the clamping arms 12 and the lateral base bodies 27 caused by excessive movements. In another embodiment, the abutting portion 13 and the base 2 may be integrally formed, or the abutting portion 13 may be separately formed.

As shown in FIG. 5, the two abutting portions 13 are respectively located between and are in contact with the two clamping arms 12 and the corresponding inner wall of the accommodating cavity 21. One of the abutting portions 13, one of the clamping arms 12, and the inner wall of the accommodating cavity 21 jointly form one air chamber 23. The other abutting portion 13, the other clamping arm 12, and an inner wall of the accommodating cavity 21 jointly form the other air chamber 23. Air is located in the two air chambers 23. A width of the connecting portion 121 gradually decreases towards a direction of the clamping portion 122. When the air enters the air chamber 23, the connecting portion 121 guides the air to flow.

As shown in FIG. 5, when the air does not enter the air chamber 23, an inner wall of the base 2 laterally abuts the first protruding portion 131. An end of the abutting portion 13 near the main body portion 11 is in contact with the inner wall of the base 2. When the air enters the air chamber 23, the inner wall of the base 2 is separated from the first protruding portion 131, and the end of the abutting portion 13 near the main body portion 11 is in contact with the inner wall of the base 2. The first protruding portion 131 prevents excessive movement of the clamping member 1 to collide with the lateral base bodies 27, thereby preventing damages to the clamping arms 12. A reserved groove 132 is disposed at a joint location between the first protruding portion 131 and the abutting portion 13. The inner wall of the base 2 partially enters the reserved groove 132 to reduce a contact surface between the lateral base bodies 27 and the first protruding portion 131 and reduce a collision force. The abutting portion 13 is obliquely provided along a direction away from the connecting portion 121, and an inner wall of the base 2 is obliquely provided correspondingly, to implement lateral movements of the clamping arms 12.

As shown in FIG. 5, the air opening 22 penetrates through the front base body 24 along an extending direction of the clamping arms 12. The main body portion 11 and the two clamping arms 12 are located between the two lateral base bodies 27. Each of the abutting portions 13 is in contact with an end of the lateral base bodies 27 away from the front base body 24. The front base body 24, the main body portion 11, the connecting portion 121, the abutting portion 13, and the inner wall of the accommodating cavity 21 surroundingly form the air chamber 23. The air chamber 23 is configured for storing the air. A height of the main body portion 11, a height of the connecting portion 121, a height of the abutting portion 13 and heights of the two lateral base bodies 27 are the same, and the main body portion 11, the connecting portion 121, and the abutting portion 13 are located between the upper base body 25 and the lower base body 26. The front base body 24 abuts the two lateral base bodies 27 and the main body portion 11, so that the air chamber 23 can be airtight.

As shown in FIG. 5, the air opening 22 is in communication with the accommodating cavity 21 and the air chamber 23. The air opening 22 is configured for entry of the air and keeps the air in the air chamber 23. The clamping portion 122 is located outside the air chamber 23. When the air does not enter the air chamber 23, the to-be-clamped object 5 is configured to be located in the gap 8, and the two clamping portions 122 are not in contact with the to-be-clamped object 5. When the air enters the air chamber 23, the to-be-clamped object 5 is located in the gap 8, and the two clamping portions 122 clamp the to-be-clamped object 5. The clamping portion 122 is located outside the air chamber 23, so that the clamping portion 122 can freely clamp or loosen the to-be-clamped object 5.

As shown in FIG. 5 and FIG. 6, each of the two sides of the main body portion 11 forms an air groove 274 respectively corresponding to one of the first grooves 271. Each of the air grooves 274, the air opening 22, and the air chamber 23 are in communication with one another. The air enters the air chamber 23 by sequentially passing through the air opening 22 and the air grooves 274. The air opening 22 and the two air grooves 274 are partially staggeredly provided along an extending direction of the clamping arms 12. The air is divided and can respectively enter the two air chambers 23. The pneumatic clamping component 100 clamps or loosens the to-be-clamped object 5 by the two air chambers 23 matching with the two clamping arms 12. Likewise, alternatively, in the pneumatic clamping component 100, one of the clamping arms 12 implements the lateral movement by one of the air grooves 274 in communication with one of the air chambers 23, and the other clamping arm 12 is held stationary, so that the two clamping arms 12 jointly clamp or loosen the to-be-clamped object 5. As the air enters the air chamber 23, one of the clamping arms 12 starts to move along the direction toward the other clamping arm 12, and the other clamping arm 12 is always stationary. The to-be-clamped object 5 is located in the gap 8. The two clamping arms 12 match each other to clamp the to-be-clamped object 5.

As shown in FIG. 5, a sealing member 6 is provided between each of the abutting portions 13 and the inner wall of the base 2. The sealing member 6 respectively abuts the abutting portion 13 and the inner wall of the base 2. The sealing member 6 is located in the accommodating groove 273, and the sealing member 6 presses against the abutting portion 13. The sealing member 6 seals the air chamber 23.

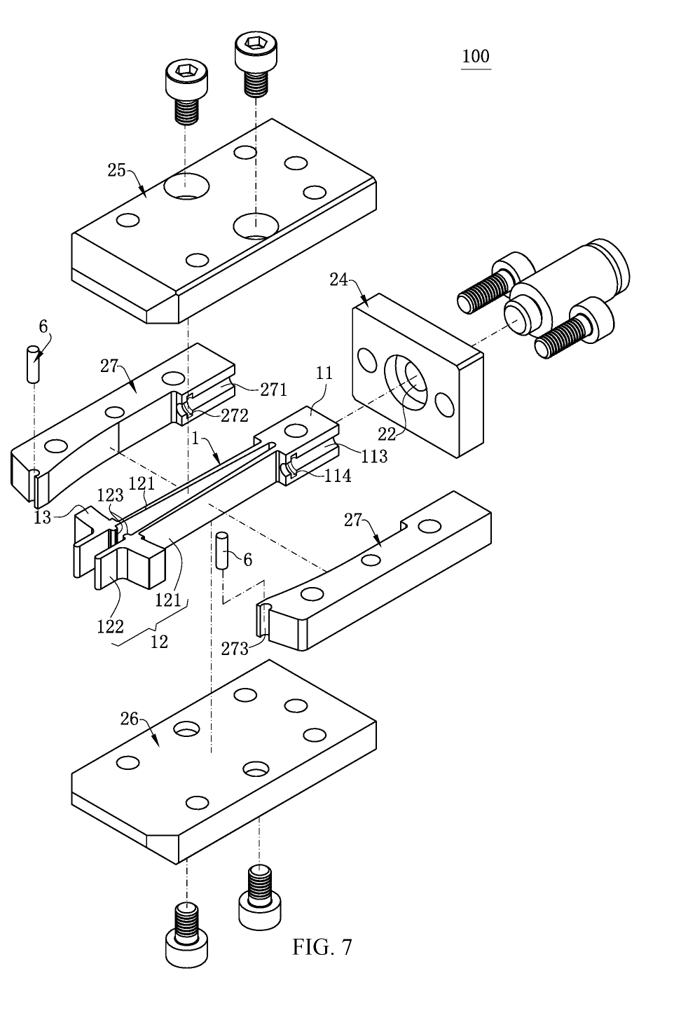

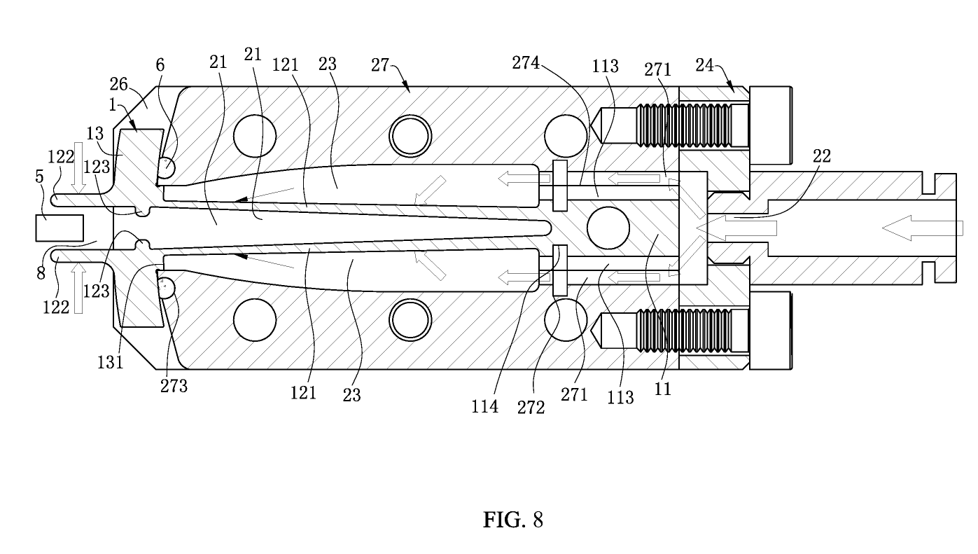

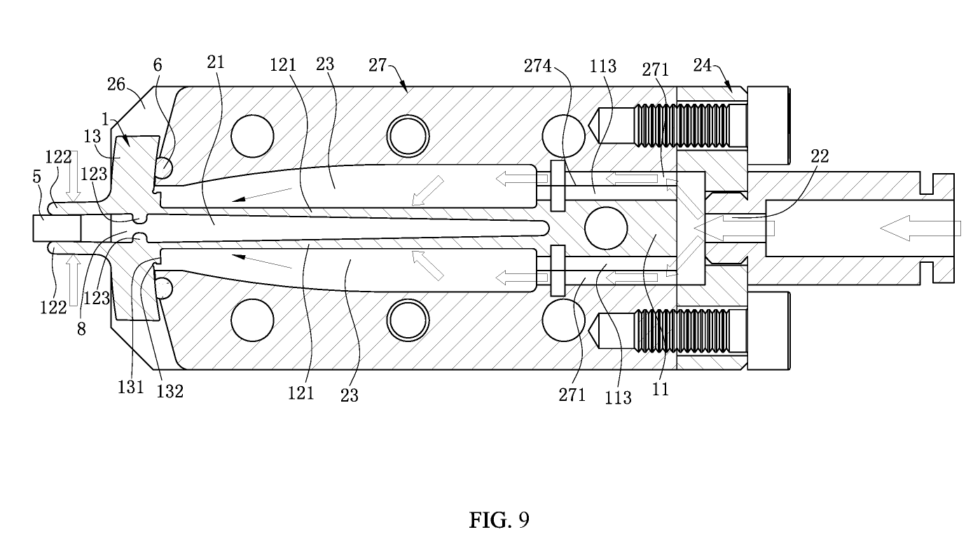

FIG. 7, FIG. 8, and FIG. 9 show a second embodiment of the present invention. The difference in this embodiment from the first embodiment exists in that, in the second embodiment, two second protruding portions 123 are respectively provided on the two clamping arms 12 and are located in the gap 8. The two second protruding portions 123 are provided opposite to each other, in order to limit lateral movements of the clamping portions 122, and prevent collision between the two clamping portions 122 when there is no to-be-clamped object in the gap 8. Two second grooves 113 are respectively provided at the two sides of the main body portion 11. Each of the first grooves 271 and each of the second grooves 113 correspondingly form one of the air grooves 274. When the main body portion 11, the connecting portions 121 and the abutting portions 13 are made of a sealing material, the air chambers 23 may store the air in a sealing manner without matching with the sealing members 6.

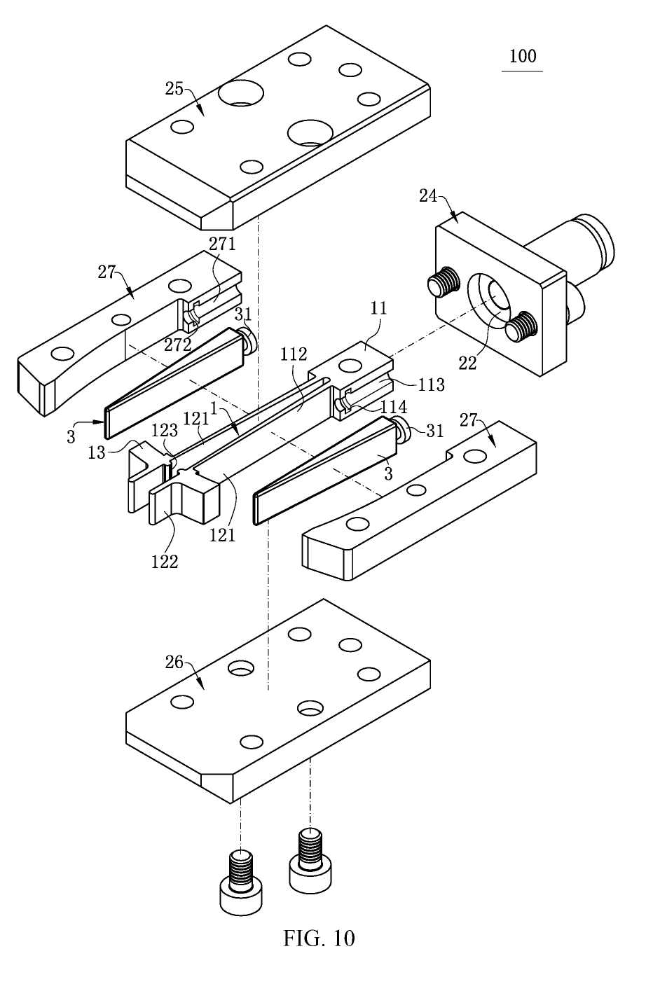

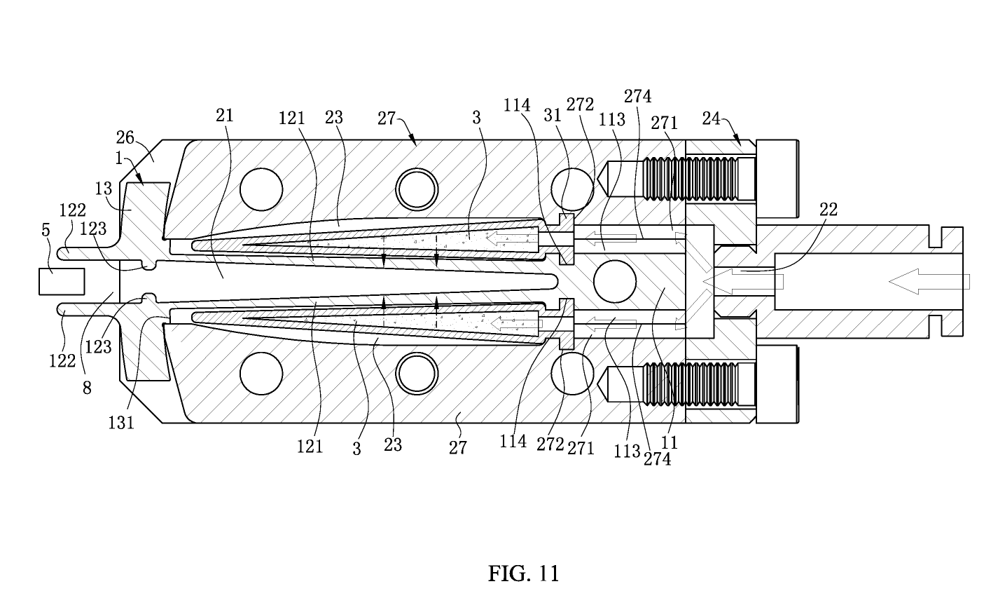

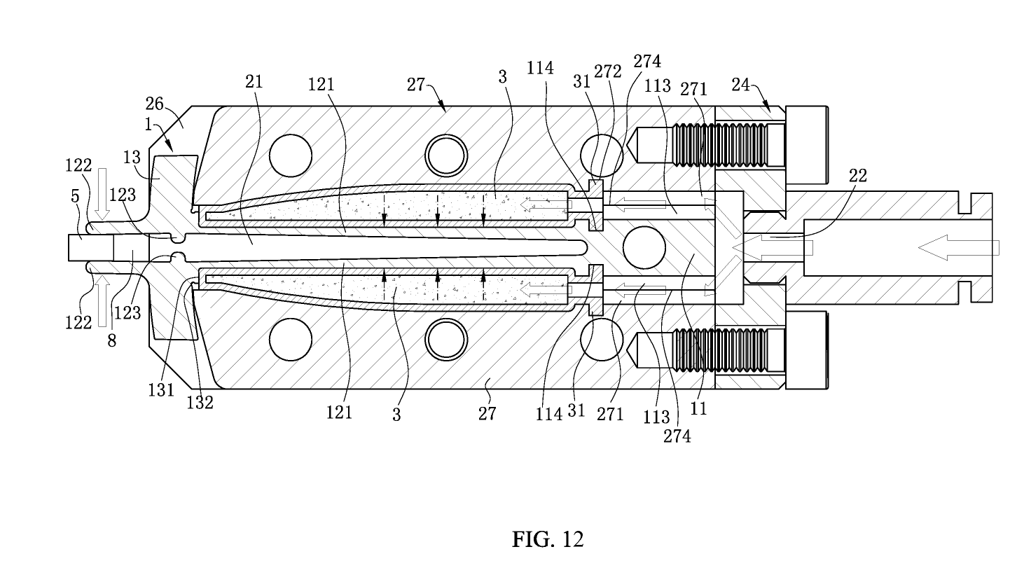

FIG. 10, FIG. 11, and FIG. 12 show a third embodiment of the present invention. The difference in this embodiment from the second embodiment exists in that, in the third embodiment, two first airbags 3 are accommodated in the air chambers 23. Each first airbag 3 includes a first air nozzle 31. The first air nozzle 31 is in communication with the air opening 22. The air enters the first air nozzle 31 through the air opening 22 and is located in the first airbag 3. The inner walls of the accommodating cavity 21 is concavely provided with two first grooves 271 opposite to each other. The two sides of the main body portion 11 are correspondingly provided with two second grooves 113 respectively. Each of the first grooves 271 and each of the second grooves 113 correspondingly form an air groove 274. Each of the first grooves 271 is concavely provided with a first recess portion 272 at a location away from the air opening 22. Each of the second grooves 113 is concavely provided with a second recess portion 114 correspondingly. The first recess portion 272 and the second recess portion 114 are respectively in lateral communication with the air grooves 274. The first air nozzles 31 are located in the first recess portion 272 and the second recess portion 114. The air sequentially enters the air opening 22 and the air groove 274 and is located in the first airbag 3. The first airbag 3 can seal the air without the sealing member 6. In another embodiment, in the pneumatic clamping component 100, alternatively, only one of the first airbags 3 is used to match one of the corresponding clamping arms 12 to implement lateral movement, and the other clamping arm 12 is held stationary.

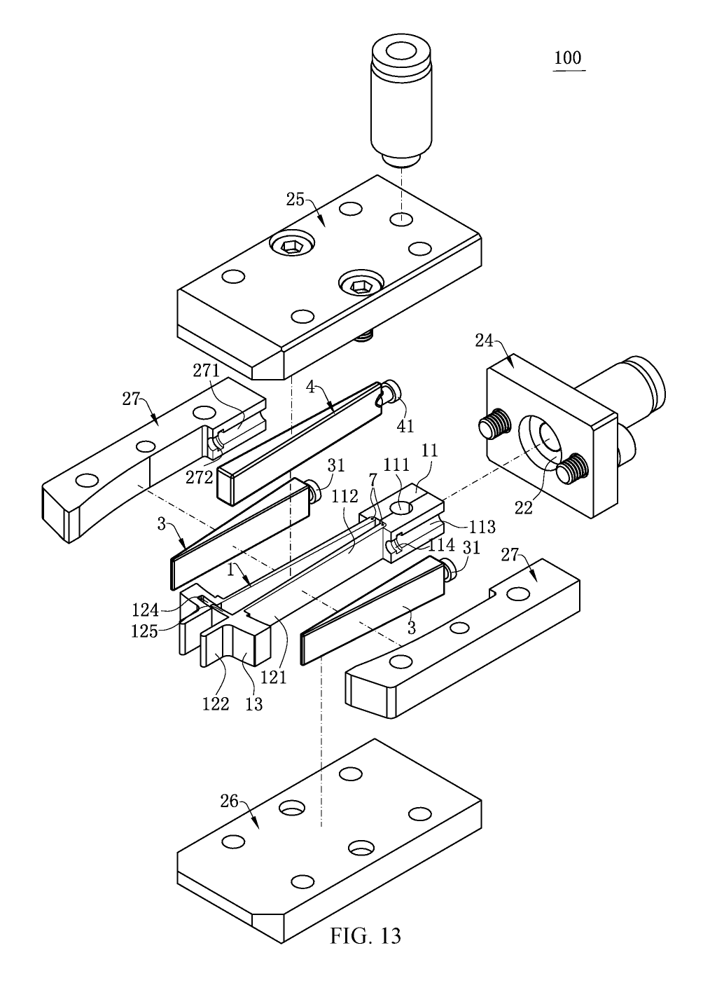

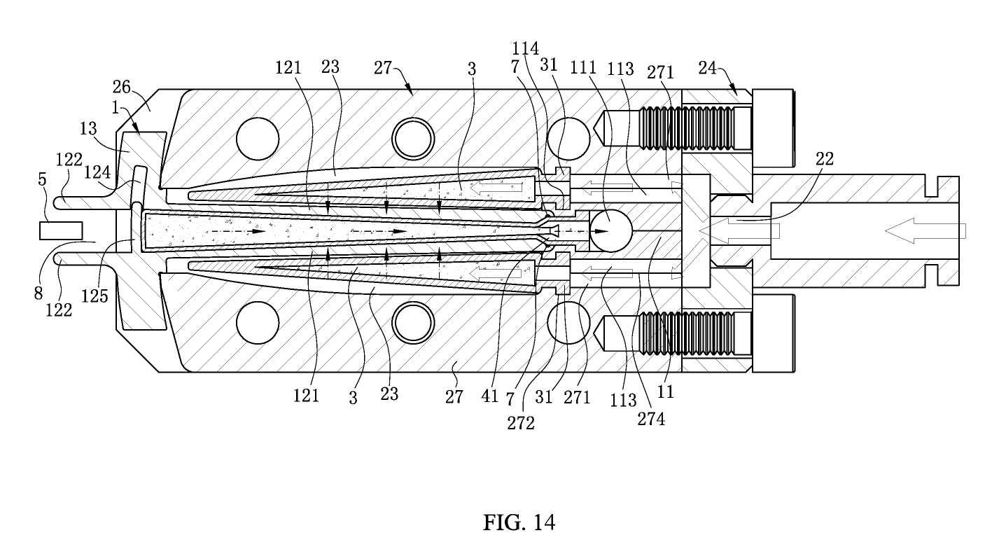

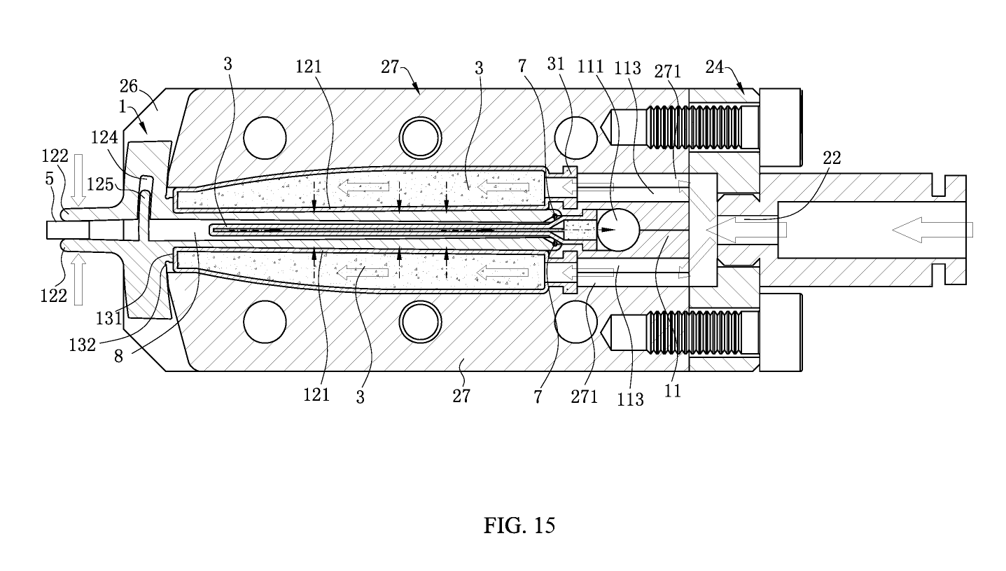

FIG. 13, FIG. 14, and FIG. 15 show a fourth embodiment of the present invention. The difference in this embodiment from the third embodiment exists in that, in the fourth embodiment, there is a second airbag 4, which is located in the gap 8, and the second airbag 4 includes a second air nozzle 41, and a through hole 111 is located in the main body portion 11. The second air nozzle 41 is in communication with the through hole 111. The air enters the second air nozzle 41 through the through hole 111 and is located in the second airbag 4. When the air enters the first airbag 3 through the air opening 22, the first airbag 3 is located between the clamping arms 12 and the lateral base bodies 27. The clamping arms 12 move along the direction away from the lateral base bodies 27. The to-be-clamped object 5 is located in the gap 8, and the two clamping portions 122 clamp the to-be-clamped object 5. The air in the second airbag 4 is discharged through the through hole 111. When the air enters the second airbag 4 through the through hole 111, the second airbag 4 is located between the two clamping arms 12. The two clamping arms 12 laterally move respectively. The air in the first airbag 3 is discharged through the air opening 22. The first airbag 3 and the second airbag 4 are made of elastic materials. Therefore, volumes of the first airbag 3 and the second airbag 4 can change due to the air. When the air enters the first airbag 3 or the second airbag 4, the volume of the first airbag 3 or the second airbag 4 increases. When the air escapes from the first airbag 3 or the second airbag 4, the volume of the first airbag 3 or the second airbag 4 decreases. The to-be-clamped object 5 is clamped or loosened by the clamping arms 12 with the change of the volume of the first airbag 3 or the second airbag 4.

As shown in FIG. 14, the connecting portion 121 is movably connected to the main body portion 11 by a fixing member 7. A pin is disposed on the fixing member 7, and the pin penetrates through the connecting portion 121, so that the connecting portion 121 is connected to the main body portion 11 to implement the lateral free movement of the clamping arm 12. In addition, one of the clamping arms 12 extends along a direction towards the other clamping arm 12 to form an inserting portion 125. The abutting portion 13 is formed by extending from a side of the other clamping arm 12 away from the gap 8. The other clamping arm 12 is correspondingly provided with a inserting opening 124, and the inserting opening 124 further extends into the abutting portion 13. When the air enters the air chamber 23, the inserting portion 125 is located on the inserting opening 124. The inserting opening 124 performs a limiting function and prevents the excessive movement of the clamping arms 12.

To sum up, the pneumatic clamping component 100 according to certain embodiments of the present invention has the following beneficial effects:

(1) The pneumatic clamping component 100 is provided with the two clamping arms 12, and the abutting portions 13, the clamping arms 12, and the inner wall of the accommodating cavity 21 jointly form the air chambers 23. The air enters the air chambers 23 through the air openings 22, and directly arrives at the air chambers 23 through the air openings 22, so that the flow path of the air is short, and the efficiency is effectively improved.

(2) The gap 8 is located between the two connecting portions 121 and extends to be between the two clamping portions 122. When the air does not enter the air chamber 23, the to-be-clamped object 5 is configured to be located in the gap 8, and the two clamping portions 122 are not in contact with the to-be-clamped object 5. When the air enters the air chamber 23, the to-be-clamped object 5 is located in the gap 8, so that the two clamping portions 122 clamp the to-be-clamped object 5. Compared with a conventional pneumatic clamping component in which a piston is pushed by using the air to match a transmission mechanism, the entire pneumatic clamping component 100 does not need a mechanical auxiliary mechanism, has a simple structure and is easy to be assembled, thereby reducing costs.

(3) The upper base body 25, the lower base body 26, the lateral base bodies 27, and the front base body 24 jointly and surroundingly form the accommodating cavity 21. The main body portion 11 and the two clamping arms 12 are located between the two lateral base bodies 27. The clamping portion 122 is located outside the air chamber 23. The entire pneumatic clamping component 100 is complete and compact, occupies a small space, and is easy and convenient to be disassembled and repaired. The gap 8 is located between the two connecting portions 121, and extends to be between the two clamping portions 122, so that collision caused by excessive movements between the clamping arms 12 is reduced, elasticity of the clamping arms 12 is maintained, and it is easier to clamp the to-be-clamped object 5.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A pneumatic clamping component, configured for entry of air so as to clamp a to-be-clamped object, comprising:
a clamping member, comprising a main body portion, wherein at least two clamping arms are provided at a side of the main body portion, each of the clamping arms comprises a connecting portion and a clamping portion extending from the connecting portion, the connecting portion is connected to the main body portion, and the clamping portion is configured for clamping the to-be-clamped object;
at least one base, comprising an accommodating cavity, at least one air opening being in communication with the accommodating cavity; and at least one abutting portion located between and in contact with one of the clamping arms and a corresponding inner wall of the accommodating cavity, wherein the abutting portion, the one of the clamping arms, and the inner wall of the accommodating cavity jointly form an air chamber, the air opening is in communication with the air chamber, the air opening is configured for entry of air and keeping the air in the air chamber, and the clamping portion is located outside the air chamber; and
at least one gap located between the two connecting portions and extending to be between the two clamping portions, wherein when the air does not enter the air chamber, the to-be-clamped object is configured to be located in the gap, and the two clamping portions are not in contact with the to-be-clamped object; and when the air enters the air chamber, the to-be-clamped object is located in the gap, and the two clamping portions clamp the to-be-clamped object.

2. The pneumatic clamping component according to claim 1, wherein the base comprises an upper base body and a lower base body provided opposite to each other, two lateral base bodies provided opposite to each other and jointly forming the accommodating cavity with the upper base body and the lower base body, and a front base body located at a front end of the accommodating cavity, wherein the main body portion and the two clamping arms are located between the two lateral base bodies, the abutting portion is in contact with an end of each of the lateral base bodies away from the front base body, and the front base body, the main body portion, the connecting portion, the abutting portion and the inner wall of the accommodating cavity surroundingly form the air chamber.

3. The pneumatic clamping component according to claim 2, wherein the air opening penetrates through the front base body along an extending direction of the clamping arms.

4. The pneumatic clamping component according to claim 2, wherein the two lateral base bodies, the upper base body, the lower base body, and the front base body are separately formed, and are assembled to one another to form the base.

5. The pneumatic clamping component according to claim 2, wherein a height of the main body portion, a height of the connecting portion, a height of the abutting portion and heights of the two lateral base bodies are same, the main body portion, the connecting portion, the abutting portion are located between the upper base body and the lower base body, and the front base body abuts the two lateral base bodies and the main body portion.

6. The pneumatic clamping component according to claim 1, wherein the inner wall of the accommodating cavity is concavely provided with two first grooves opposite to each other, the two sides of the main body portion form two air grooves respectively corresponding to the first grooves, each of the air grooves, the air opening and the air chamber are in communication with one another, and the air enters the air chamber by sequentially passing through the air opening and the air grooves.

7. The pneumatic clamping component according to claim 6, wherein the two sides of the main body portion are correspondingly provided with two second grooves respectively, and each of the first grooves and each of the second grooves correspondingly form one of the air grooves.

8. The pneumatic clamping component according to claim 6, wherein the air opening and the two air grooves are staggeredly provided along an extending direction of the clamping arms.

9. The pneumatic clamping component according to claim 1, wherein two abutting portions are provided, the two abutting portions are respectively located between and are in contact with the two clamping arms and the corresponding inner wall of the accommodating cavity; wherein air is located in two air chambers, one of the abutting portions, one of the clamping arms, and the inner wall of the accommodating cavity jointly form one of the air chambers, and the other of the abutting portions, the other of the clamping arms, and the inner wall of the accommodating cavity jointly form the other of the air chambers.

10. The pneumatic clamping component according to claim 1, wherein the abutting portion is formed by integrally extending from one of the clamping arms.

11. The pneumatic clamping component according to claim 10, wherein a first protruding portion is provided at a joint location between the abutting portion and the connecting portion, wherein when the air does not enter the air chamber, an inner wall of the base laterally abuts the first protruding portion, and an end of the abutting portion near the main body portion is in contact with the inner wall of the base; and when the air enters the air chamber, the inner wall of the base is separated from the first protruding portion, and the end of the abutting portion near the main body portion is in contact with the inner wall of the base.

12. The pneumatic clamping component according to claim 11, wherein a reserved groove is provided at a joint location between the first protruding portion and the abutting portion, and the inner wall of the base partially enters the reserved groove.

13. The pneumatic clamping component according to claim 1, wherein a sealing member is provided between the abutting portion and an inner wall of the base, and the sealing member respectively abuts the abutting portion and an inner wall of the base.

14. The pneumatic clamping component according to claim 13, wherein the inner wall of the base is concavely provided with an accommodating groove, the sealing member is located in the accommodating groove, and the sealing member presses against the abutting portion.

15. The pneumatic clamping component according to claim 1, wherein the abutting portion is obliquely provided along a direction away from the connecting portion, and an inner wall of the base is obliquely provided correspondingly.

16. The pneumatic clamping component according to claim 1, wherein two extending portions are provided at one end of the main body portion near the connecting portion, and the two extending portions are respectively located on two sides of the two connecting portions away from the gap.

17. The pneumatic clamping component according to claim 1, wherein the main body portion, the connecting portion, and the abutting portion are made of a sealing material.

18. The pneumatic clamping component according to claim 1, wherein a width of the connecting portion gradually decreases towards a direction of the clamping portions.

19. The pneumatic clamping component according to claim 1, wherein each of the two clamping arms is provided with a second protruding portion located in the gap.

20. The pneumatic clamping component according to claim 1, wherein at least one of the connecting portions is movably connected to the main body portion by a fixing member.

21. The pneumatic clamping component according to claim 1, wherein one of the clamping arms extends along a direction towards the other of the clamping arms to form an inserting portion, the other of the clamping arms is correspondingly provided with a inserting opening, and when the air enters the air chamber, the inserting portion is located on the inserting opening.

22. The pneumatic clamping component according to claim 21, wherein the abutting portion is formed by extending from a side of the other of the clamping arms away from the gap, and the inserting opening further extends into the abutting portion.

23. The pneumatic clamping component according to claim 1, wherein at least one first airbag is accommodated in the air chamber, the first airbag comprises a first air nozzle in communication with the air opening, and the air enters the first air nozzle through the air opening and is located in the first airbag.

24. The pneumatic clamping component according to claim 23, wherein the inner wall of the accommodating cavity is concavely provided with two first grooves opposite to each other, the two sides of the main body portion are correspondingly provided with two second grooves respectively, and each of the first grooves and each of the second grooves correspondingly form an air groove, each of the first grooves is concavely provided with a first recess portion at a location away from the air opening, each of the second grooves is concavely provided with a second recess portion correspondingly, the first recess portion and the second recess portion are respectively in lateral communication with the air groove, the first air nozzles are located in the first recess portion and the second recess portion, and the air sequentially enters the air opening and the air groove to be located in the first airbag.

25. The pneumatic clamping component according to claim 1, wherein at least one second airbag is located in the gap, the second airbag comprises a second air nozzle; a through hole is located in the main body portion, and the second air nozzle is in communication with the through hole, wherein the air enters the second air nozzle through the through hole to be located in the second airbag.
